(19) United States
(12) Patent Application Publication
(10) Pub. No.: US 2010/0098048 A1
(43) Pub. Date: Apr. 22, 2010

(54) METHOD FOR HYBRID MEDIUM ACCESS CONTROL FOR VEHICLE COMMUNICATION

(75) Inventors: Moonsoo KANG, Daejeon (KR); Sangwoo Lee, Daejeon (KR); Jeonghoon Mo, Seoul (KR); Hyun Jeong Yun, Daejeon (KR); Kyeong-Soo Han, Daejeon (KR); Hyun Seo Oh, Daejeon (KR); Dong Yong Kwak, Daejeon (KR); Jeongseok Ha, Daejeon (KR)

Correspondence Address: STAAS & HALSEY LLP, SUITE 700, 1201 NEW YORK AVENUE, N.W., WASHINGTON, DC, 20005, US

(73) Assignees: ELECTRONICS AND TELECOMMUNICATIONS RESEARCH INSTITUTE, Daejeon (KR); KOREA ADVANCED INSTITUTE OF SCIENCE AND TECHNOLOGY, Daejeon-city (KR)

(21) Appl. No.: 12/474,963

(22) Filed: May 29, 2009

(30) Foreign Application Priority Data
Oct. 20, 2008 (KR) 10-2008-0102640

(51) Int. Cl. H04J 3/00; H04L 12/413

(52) U.S. Cl. 370/345; 370/445

(57) ABSTRACT

A method for hybrid media access control for vehicle communication is provided. The method divides a radio channel into time slots, which are predetermined time units, and sets terminals as owners or non-owners for the divided time slots to be able to access the channel. Accordingly, it is possible to reduce the probability of contention by distributed access to the slots and provide a MAC protocol having excellent performance.

### CROSS-REFERENCE TO RELATED APPLICATION

This application claims priority to and the benefit of Korean Patent Application No. 10-2008-0102640 filed in the Korean Intellectual Property Office on Oct. 20, 2008, the entire contents of which are incorporated herein by reference.

### BACKGROUND OF THE INVENTION

(a) Field of the Invention

The present invention relates to a method for medium access control, and in more detail, a method for medium access control in a vehicle communication environment.

(b) Description of the Related Art

In general, unlike existing communication between base stations and terminals, in communication between vehicles, terminals provided in the vehicles form a communication network by themselves without control of base stations and perform communication by their distributed control. In communication between vehicles, the communication is affected by characteristics such as frequent changes in topology due to high-speed traveling of the vehicles and increases in the number of terminals due to traffic jams.

Currently, IEEE 802.11 CSMA/CA (Carrier Sense Multiple Access/Collision Avoidance), which is a standard of wireless LAN, has been researched as a MAC (Medium Access Control) protocol of communication between vehicles. Basically, the structure of MAC is made by a DCF (Distributed Coordination Function) based on CSMA/CA.

A typical type of channel access method is described with reference to FIG. 1. A channel access method of a CSMA/CA type is exemplified herein.

FIG. 1 is a flowchart illustrating a typical channel access method.

As shown in FIG. 1, when a message is received from an upper layer (S10), examination of whether a channel is available is firstly performed by checking whether the channel is in an idle state (S11). If the channel is in an idle state, it is again determined whether the channel is in an idle state (S13) after waiting for a predetermined time (S12). If it is determined that the channel is in the idle state as a result of S13, a frame is transmitted (S14). The predetermined time implies a DIFS (DCF Inter-Frame Space).

If the channel is busy when the message is transmitted from the upper layer, a terminal waits until transmission of a frame that is being transmitted is finished. The DIFS is also included in the waiting time (S15). Each terminal has a predetermined contention window value, and waits for “contention window value×slot time” after the DFIS, that is, a backoff time (S16). The channel is examined at each time slot (S17), and the contention window values are decreased one by one only when the channel is in the idle state (S18).

However, when the channel is busy, the contention window values are not decreased (S19). Thereafter, the terminal determines whether the contention window value is 0 (S20), and transmits a frame if it is 0 (S14).

As described above, according to the communication between vehicles using the CSMA/CA in the related art, the terminals provided in vehicles compete with each other to transmit a signal, and the terminal that has won in the contention gains a radio channel and starts transmission. The terminals that have lost in the contention increase their contention window (also called “CW”) and participate in a contention again.

Further, when two or more terminals simultaneously perform transmission, transmission collision occurs. In this case, in common methods, the throughput increases with an increase in the number of terminals, and the throughput decreases after reaching a predetermined level.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method for hybrid media access control for vehicle communication having advantages of dividing a radio channel into time slots, and allows terminals to access the divided channel.

In order to achieve the technical object of the present invention, a method for media access control according to an aspect of the present invention includes: determining whether a channel composed of a plurality of slots is in an idle state when a data frame to be transmitted by a terminal is generated, wherein the data frame is transmitted through a time frame and the time frame is composed of a plurality of slots; determining whether the terminal is a slot owner for the present slot with the frame in the plurality of slots, when the channel is not in the idle state; setting a first contention window value and re-determining whether the channel is in the idle state, when the terminal is a slot owner for the present slot; deducting one from the first contention window value and determining whether the reduced contention window value is a predetermined value, when the channel is in the idle state; and transmitting the frame through the present slot of the channel, when the reduced contention window value is the predetermined value.

In order to achieve the technical object of the present invention, a method for media access control to transmit frames using a plurality of terminals in vehicle communication according to another aspect of the present invention includes: transmitting a first data frame from a first slot by a first terminal that is one of the plurality of terminals, wherein each of a plurality of time frames forming a channel is composed of a plurality of slots and the first terminal is a slot owner of a first slot in the plurality of slots; determining whether the channel is in an idle state such that a second terminal that is a slot owner of the first slot-transmits a second data frame and a third terminal that is a non-owner of the first slot transmits a third data frame, while the first data frame is transmitted; setting contention window values by the second terminal and the third terminal when the channel is not in the idle state; transmitting the second data frame of the second terminal when transmission of the first data frame is finished; and transmitting the third data frame of the third terminal when transmission of the second data frame is finished.

Accordingly, the present invention divides a radio channel into time slots, which are predetermined time units, and sets terminals as owners or non-owners of the divided time slots to be able to access the channel. Therefore, it is possible to reduce the probability of contention between terminals and provide a MAC protocol having excellent performance, because distributed access of the terminals to the slots is possible.

### BRIEF DESCRIPTION OF THE DRAWINGS

FIG. 1 is a flowchart illustrating a typical channel access method.

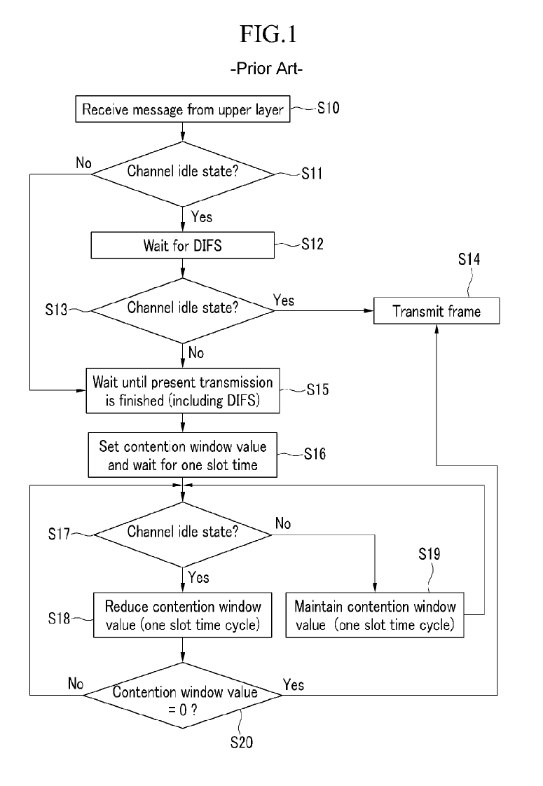

FIG. 2 is an exemplary view of a channel configuration according to an exemplary embodiment of the present invention.

FIG. 3 is an exemplary view illustrating the contention window relationship according to an exemplary embodiment of the present invention.

FIG. 4 is a flowchart illustrating a channel access method according to an exemplary embodiment of the present invention.

FIG. 5 is an exemplary view illustrating the operation of a MAC protocol according to an exemplary embodiment of the present invention.

FIG. 6 is an exemplary view illustrating changes in throughput according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements.

In the specification, a terminal may designate a mobile station (MS), a mobile terminal (MT), a subscriber station (SS), a portable subscriber station (PSS), user equipment (UE), an access terminal (AT), etc., and may include the entire or partial functions of the mobile terminal, the subscriber station, the portable subscriber station, the user equipment, etc.

In the specification, a base station (BS) may designate an access point (AP), a radio access station (RAS), a node B, a base transceiver station (BTS), and a mobile multihop relay (MMR)-BS, etc., and may include the entire or partial functions of the access point, the radio access station, the node B, the base transceiver station, the MMR-BS, etc.

A method of transmitting a data frame according to an exemplary embodiment of the present invention is described hereafter in detail with reference to the accompanying drawings.

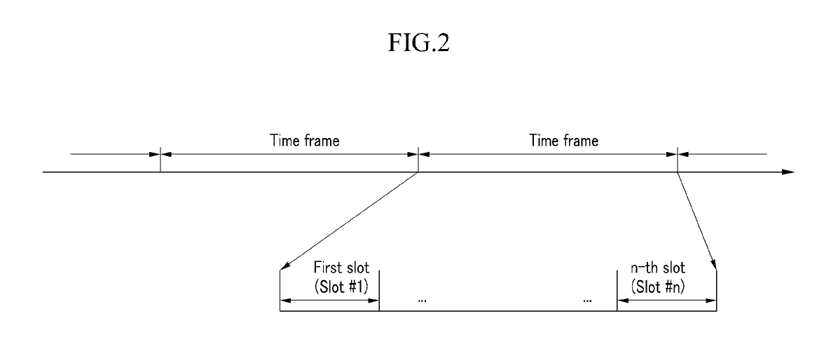

FIG. 2 is an exemplary view of a channel configuration according to an exemplary embodiment of the present invention.

As shown in FIG. 2, a channel according to an exemplary embodiment of the present invention is composed of a plurality of time frames, and each of the time frames is composed of a plurality of slots (slot #1-slot #n, where n is an integer). The slot is composed of a control slot and a service slot, and the number of slots and the slot configuration (configuration of the control slot and the service slot) are adjustable in one time frame. The control slot performs transmission including a MAC management frame and a safety-related frame, and the service slot performs transmission including a safety-related frame and a general data frame.

Each terminal determines a transmission slot for transmitting a data frame for every time frame. A method of determining a transmission slot according to an exemplary embodiment of the present invention can be implemented in various ways, and is not particularly limited. For example, as a method of determining a transmission slot, there is a method of randomly selecting a transmission slot for transmitting a data frame in a time frame composed of a plurality of slots, and a method of variably selecting a transmission slot according to time by detecting load of the present network. The method of selecting a transmission slot by detecting load of the present network can be divided into a method of selecting a transmission slot on the basis of the speed of a vehicle, and a method of selecting a transmission slot on the basis of a retransmission counter.

The method of selecting a transmission slot on the basis of the speed of a vehicle implies a method that makes it possible to use fewer slots when a vehicle travels at a low speed and use more slots when the vehicle travels at a high speed. Further, the method of selecting a transmission slot on the basis of retransmission counter makes it possible to transmit a data frame by using less slots when the retransmission counter value increases and by using more slots when the retransmission counter value decreases.

The terminal determines many transmission slots in the entire slots to select how on the basis of one of the methods described above. For example, it is determined according to the methods described above whether to select one or m (1<m≦n) service slots of n service slots. Each terminal is a slot owner for the transmission slot selected by itself, and is a non-owner for the other slots. Further, a slot owner has a transmission priority for the corresponding slot.

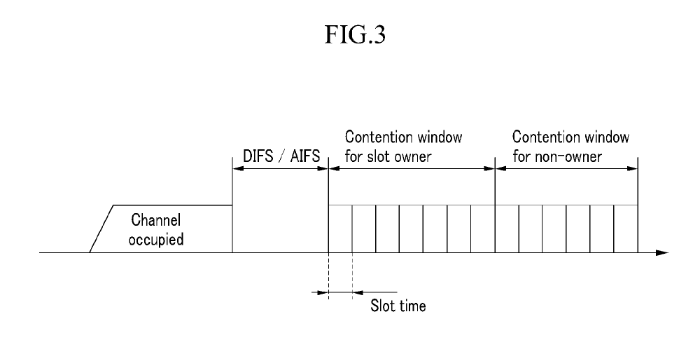

Next, the contention window relationship between a slot owner and a non-owner when a terminal selects a slot according to the method illustrated in FIG. 2 is described with reference to FIG. 3.

FIG. 3 is an exemplary view illustrating the contention window relationship according to an exemplary embodiment of the present invention.

As shown in FIG. 3, all of terminals wait for a DIFS from when they can use channels. The terminals select the magnitudes of contention windows to use, for the DIFS waiting time. In an exemplary embodiment of the present invention, the terminals randomly select contention window values within a contention window range (CWmin≦CW≦CWmax, where CW is an integer), and have different window selection ranges in accordance with the priorities of corresponding slots, that is, whether they are slot owners or non-owners.

If a terminal is a slot owner for the corresponding slot, the slot owner selects a contention window having a magnitude that is smaller than that of non-owners, such that it can preferentially access the channel of the corresponding slot. In the above operation, it is common for the slot owner to select a contention window having a smaller magnitude than that of the non-owners, and a detailed description is not provided in the exemplary embodiments of the present invention. Further, it is assumed that if a terminal is a slot owner, it does not select a contention window having a larger magnitude than that of the non-owners.

A plurality of terminals that are slot owners may exist in one slot. In this case, the terminal that has selected the smallest contention window in the contention windows selected by the terminals, which are slot owners, transmits a data frame from the corresponding time frame. In selecting a slot as described above, it is possible to reduce the probability of slot selection contention by using a distributed selection method of separating the slot owners and non-owners, and to maintain the CWmax value.

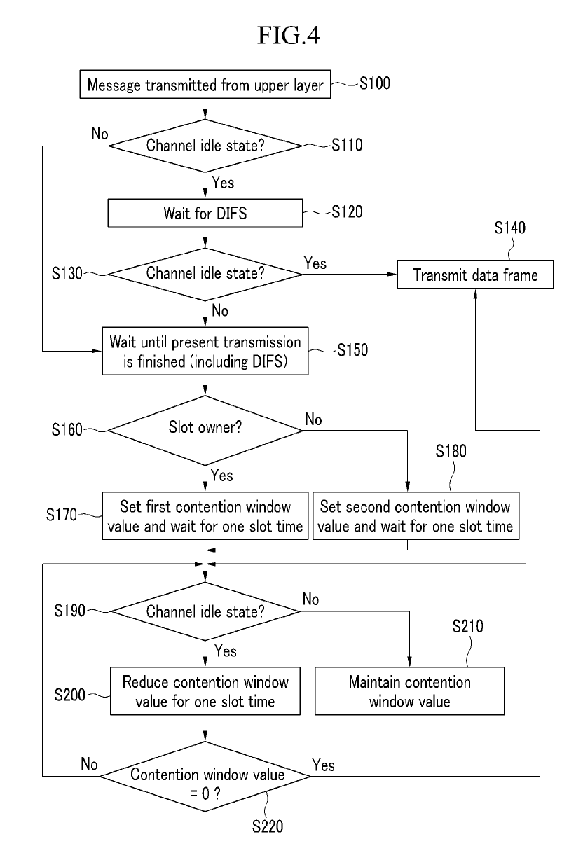

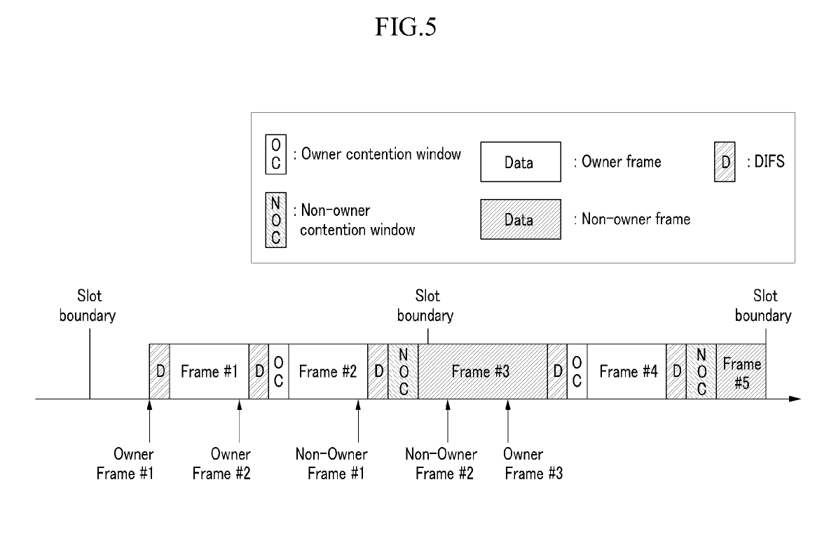

Next, a channel access method of a terminal by allocation of a slot according to an exemplary embodiment of the present invention and a corresponding MAC protocol are described with reference to FIG. 4 and FIG. 5.

FIG. 4 is a flowchart illustrating a channel access method according to an exemplary embodiment of the present invention, and FIG. 5 is an exemplary view illustrating the operation of a MAC protocol according to an exemplary embodiment of the present invention.

First, as shown in FIG. 4, a data message requested for transmission is transmitted from an upper layer, such as a network layer (S100), and a terminal examines whether the present channel is available by checking that the channel is in an idle state (S110). The present channel implies the channel when the terminal substantially intends to transmit a data frame after waiting for a DIFS from when the data frame is generated, rather than the channel when a data frame to transmit is generated.

If the present channel is in an idle state, the terminal determines again whether the channel is in the idle state (S130) after waiting for the DIFS (S120). The reason for waiting for the DIFS is to check whether the channel is in the idle state by scanning the channel and checking whether there is a data frame transmitted through the corresponding channel, while waiting for the DIFS. If it is determined that the channel is in the idle state as a result of step S130, the terminal transmits the data frame through the corresponding channel (S140).

On the other hand, if it is determined that the channel is not in the idle state as a result of step S110, the terminal waits until transmission of a data frame, which is being transmitted, is finished (S150). A DIFS is included in the waiting time to allow checking the state of the channel for the DIFS (S150). Thereafter, the terminal determines whether it is a slot owner for the slot of the channel after the transmission of the data frame is finished (S160). That is, the terminal determines whether the slot of the channel is its transmission slot.

If the corresponding terminal is a slot owner, the terminal waits for a predetermined slot time while selecting a first contention window value (S170). It is assumed herein that, to select a contention window value according to whether the terminal is a slot owner or a non-owner, the contention window values between 0 and CWmax are divided into two sections and a contention window value in either one of the sections is selected.

For example, it is assumed that any one of the contention window values between 0 and CWo-1 is selected when the terminal is a slot owner. On the contrary, it is assumed that any one of the contention window values between CWo-1 and CWmax is selected when the terminal is a non-owner. The selection of a contention window value in either of the two sections by the terminal is not necessarily limiting

When the waiting for the slot time is finished, the terminal checks again whether the channel is in the idle state (S190). If it is determined that the channel is still in the idle state as a result of step S190, it is determined whether the contention window is a predetermined value (S220) after deducting one from the contention window value (contention window value −1) selected in step S170 (S200). The exemplary embodiment of the present invention is described under an assumption that the predetermined value is 0. Further, determining whether the contention window is 0 allows the terminal that is still waiting due to the idle state of the channel to transmit a data frame from the corresponding slot when the contention window value becomes 0 by reducing the pre-selected contention window value one by one.

When the present contention window is 0, the terminal transmits a data frame from the corresponding slot (S140). However, when the contention window is not 0, the terminal checks again whether the channel is in the idle state after waiting for the slot time (S190). Reducing the contention window is repeated at a predetermined time cycle until the contention window becomes 0. An exemplary embodiment of the present invention exemplifies when the predetermined time cycle is a one slot time cycle.

When it is determined that the terminal for the corresponding slot is not a slot owner but is a non-owner in step S160, similar to the slot owner, the terminal selects a second contention window and waits for the one slot time (S180). In this process, since the value of the second contention window selected by the non-owner is larger than the value of the first contention window selected by the slot owner, the terminal has to wait until the slot owner finishes transmitting the data frame.

When it is determined that the channel is not in the idle state in step S190, the value of the contention window is maintained (S210). Further, the process after step S190 is repeated at one slot time cycle.

The processes described above are described with reference to the exemplary view of a MAC protocol shown in FIG. 5. Before describing, although it is assumed that one terminal transmits one data frame in the exemplary embodiment of the present invention, this is not necessarily limiting. Further, it is assumed that the slot owner of a first slot includes a first terminal and a second terminal and the slot owner of a second slot includes a fourth terminal. Furthermore, it is assumed that the non-owner of the first slot is a third terminal and the non-owner of the second slot is a fifth terminal.

First, when a first owner frame (owner frame #1) that will be transmitted by the first terminal that is the slot owner of the first slot is generated at a certain time point of the first slot, the first terminal detects whether the present channel is in an idle state by examining the channel. Owner frames or non-owner frames described hereafter imply data frames. If the channel is in the idle state, the terminal detects again whether the channel is in the idle state after waiting for the DIFS. If the channel is still in the idle state, the first terminal transmits the first owner frame through the first slot.

If a second owner frame (owner frame #2) that will be transmitted by the second terminal through the first slot is generated while the first terminal transmits the first owner frame, the second terminal waits until transmission of the first owner frame is finished. The second owner frame may be the data frame that is transmitted by the first terminal, and as described above, when one terminal transmits one data frame, it may be the data frame that is transmitted by the second frame.

The second terminal selects a contention window while waiting for the DIFS right after transmission of the first owner frame is finished. When a contention window is selected and transmission of the first owner frame is finished, the second terminal transmits the second owner frame through the second slot.

If a first non-owner frame (non-owner frame #1) that will be transmitted by the third terminal that is the non-owner frame of the first slot is generated while the second owner frame is transmitted, the third terminal selects a contention window value while waiting for the DIFS after transmission of the second owner frame is finished. Further, the third terminal may transmit the third frame if the contention window value of the first slot that is a non-owner is 0. This allows the third terminal that is a non-owner to transmit the first non-owner frame, because it is determined that there is no frame to be transmitted by the slot owners in the first slot, when the contention window value becomes 0.

Assuming that the second non-owner frame (non-owner frame #2) that will be transmitted by the fifth terminal that is a non-owner of the second slot and the third owner frame (owner frame #3) that will be transmitted by a fourth terminal that is a slot owner are sequentially generated, while the first non-owner frame is transmitted through the first slot and the second slot, the fourth terminal and the fifth terminal that will transmit the two frames perform contention for ensuring a channel and each sets a contention window.

In this process, since the fourth terminal that is a slot owner of the second slot selects a contention window value that is smaller than that of the fifth terminal that is a non-owner, it can preferentially transmit a frame even if the third owner frame that will be transmitted by the fourth terminal is generated later than the second non-owner frame. Accordingly, the third owner frame that will be transmitted by the fourth terminal is firstly transmitted. Further, the fifth terminal that is a non-owner transmits the second non-owner frame when there is no frame to be transmitted by other slot owners selecting the second slot as a transmission slot after transmission of the third owner frame is finished.

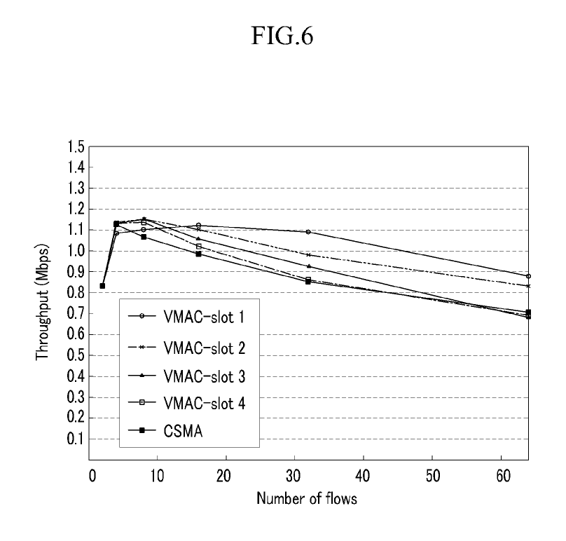

Next, a CSMA/CA method, which is a typical type, and performance changes of a method according to an exemplary embodiment of the present invention are described with reference to FIG. 6. For convenience of description, the typical CSMA/CA method is referred to as “CSMA”, and the method according to an exemplary embodiment of the present invention is referred to as “VMAC”.

FIG. 6 is an exemplary view illustrating changes in throughput according to an exemplary embodiment of the present invention.

As shown in FIG. 6, in the VMAC, it is assumed that the entire time frame is composed of four slots. A slot 1 implies using one slot of the four slots and a slot 4 implies using all four slots.

It can be seen that as the number of terminal increases, the throughput of data frame according to the typical method decreases as compared with the VMAC slot 1. In this case, with the increase of the number of terminals, contention for transmitting a data frame increases and retransmission correspondingly increases, and as a result, the probability of contention is reduced compared with when all nodes simultaneously transmit. Accordingly, it can be seen that the reduction of the number of retransmission causes throughput to be improved.

The exemplary embodiments of the present invention are implemented not only by the method and apparatus, but programs that achieve functions corresponding to the configuration of the exemplary embodiments of the present invention or recording mediums including the programs. Further, this can be easily implemented from the description of the exemplary embodiments by those skilled in the art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for media access control, comprising:
determining whether a channel composed of a plurality of slots is in an idle state when a data frame to be transmitted by a terminal is generated, wherein the data frame is transmitted through a time frame and the time frame is composed of a plurality of slots;
determining whether a channel of a time frame is in an idle state when a data frame that will be transmitted by a terminal, wherein the data frame is transmitted through the time frame and the time frame is composed of a plurality of slots, is generated;
determining whether the terminal is a slot owner for the present slot with the data frame in the plurality of slots, when the channel is not in the idle state;
setting a first contention window value and re-determining whether the channel is in the idle state, when the terminal is a slot owner for the present slot;
deducting one from the set first contention window value and determining whether the reduced contention window value is a predetermined value, when the channel is in the idle state; and
transmitting a data frame through the present slot of the channel, when the reduced contention window value is the predetermined value.

2. The method of claim 1, further comprising:
setting a second contention window value when the terminal is a non-owner for the present slot; and
waiting for a predetermined slot time.

3. The method of claim 1, wherein the terminal selects itself as a slot owner for one or more slots of the plurality of slots.

4. A method for media access control to transmit data frames using a plurality of terminals in vehicle communication, the method comprising:
transmitting a first data frame from a first slot by a first terminal that is one of the plurality of terminals, wherein each of a plurality of time frames forming a channel is composed of a plurality of slots and the first terminal is a slot owner of a first slot in the plurality of slots;
determining whether the channel is in an idle state such that a second terminal that is a slot owner of the first slot- transmits a second data frame and a third terminal that is a non-owner of the first slot transmits a third data frame, while the first data frame is transmitted;
setting contention window values by the second terminal and the third terminal when the channel is not in the idle state;
transmitting the second data frame of the second terminal when transmission of the first data frame is finished; and
transmitting the third data frame of the third terminal when transmission of the second data frame is finished.

5. The method of claim 4, wherein the contention window value set by the second terminal is larger than the contention window value set by the third terminal.

6. The method of claim 4, wherein the setting of contention window values includes:
having the second terminal and the third terminal wait for a predetermined time;
re-checking whether the channel is in the idle state by the second terminal and the third terminal; and
reducing the set contention window values one by one by the second terminal and the third terminal when the channel is in the idle state.

7. The method of claim 6, further comprising determining whether the reduced contention window values are predetermined values, and when the reduced contention windows are not the predetermined values, waiting for the predetermined time, after the reducing of the contention window values one by one.

8. The method of claim 4, wherein the first terminal, the second terminal, and the third terminal select the first terminal, the second terminal, and the third terminal themselves, respectively, as slot owners for one or more of the plurality of slots.
